(19) United States
(12) Patent Application Publication
(10) Pub. No.: US 2024/0343227 A1
(43) Pub. Date: Oct. 17, 2024

(54) ASSEMBLY FOR CLEANING A CAMERA

(71) Applicant: Siemens Mobility GmbH, München (DE)

(72) Inventor: Vladimir Stojanovic, Wien (AT)

(21) Appl. No.: 18/290,906

(22) PCT Filed: Jul. 6, 2022
(86) PCT No.: PCT/EP2022/068668

§ 371 Date: Jan. 22, 2024

(30) Foreign Application Priority Data
Jul. 22, 2021 (DE) 10 2021 207 874.5

(51) Int. Cl. B60S 1/56; B60S 1/08; B60S 1/34

(52) U.S. Cl. CPC B60S 1/566; B60S 1/08; B60S 1/3404

(57) ABSTRACT

An assembly cleans an optically translucent cover of a camera. The camera is arranged below the optically translucent cover in order to be protected against environmental influences. A wiper blade is guided over the cover to clean the cover, and the wiper blade is connected to a mounted linkage, by use of which the wiper blade can be moved over the cover between first and second positions. The linkage is coupled to an electromagnetic drive, and the drive has a drive element connected to the linkage such that the drive element linearly moves the linkage. The magnetic field built up by the coil is coupled to the drive element such that a pushing force acts on the drive element. The pushing force is transmitted to the wiper blade via the linkage to bring the wiper blade from the first position into the second position in a linear movement.

The invention relates to an assembly for cleaning a camera or an optically translucent cover of a camera.

It is known to use cameras on rail vehicles for a wide variety of purposes. Depending on the use, these cameras are of different types of design, with different mechanical dimensions or sizes.

For such a camera to function reliably, it must have a suitable cleaning system in order to be able to create images of a high quality even in adverse weather conditions (snow, ice, fog, dust, etc.) during the operation of the rail vehicle.

The German patent application with the application number DE 10 2021 206 827.8 and the filing date of Jun. 30, 2021 and the German patent application with the application number DE 10 2021 204 088.8 and the filing date of Apr. 23, 2021 disclose cameras which, with minimal size or dimensions, are arranged in the wheel-rail contact area of a rail vehicle in order to be used there in a monitoring process.

On account of their positioning, such cameras must withstand additional mechanical loads and accelerations. The mechanical forces to which such a camera is exposed in the area of the wheel disk on a rail vehicle are very high and directly proportional to the mass of the camera, which in turn influences its size.

These cameras are therefore preferably designed as so-called “mini cameras”, which correspond in their dimensioning to a camera of a cell phone (also referred to as a “mobile phone”). As a further advantage, a mini camera has a very small, optically translucent cover, which is generally produced from glass or from a translucent plastic. The camera or the camera housing or the optical image recorder of the camera is arranged behind this cover so as to be protected from environmental influences.

The small area of the cover is coupled to a heater for operation during winter and must allow itself to be cleaned easily and without smearing.

Cleaning systems for cameras of minimal dimensions for the commercial or industrial application purposes described above are so far scarcely known or entirely unknown.

In the automobile industry, cleaning systems are used to clean headlamps. These cleaning systems have a wiper motor, a wiper arm with a wiper blade, a pump for a cleaning agent, a hose and a nozzle for delivering the cleaning agent, etc., to perform this purpose.

On account of their mechanical design, such systems are too large for cleaning mini cameras and not suitable for the spatially confined operating scenarios described above.

The object of the present invention is therefore that of providing an assembly for cleaning a camera, in particular a mini camera, which, while having small dimensions, ensures a reliable cleaning effect of the optically translucent camera cover.

This object is achieved by the features of the independent patent claim. Advantageous developments are provided in the dependent patent claims.

The invention relates to an assembly for cleaning an optically translucent cover of a camera. The camera is arranged under the optically translucent cover so as to be protected from environmental influences. A wiper blade can be guided over the cover for cleaning the cover. The wiper blade is connected to a mounted linkage, with which the wiper blade can be moved over the cover between a first position and a second position. The linkage is coupled to an electromagnetic drive. The electromagnetic drive has a drive element, which is connected to the linkage in such a way that the drive element moves the linkage linearly. The magnetic field of the coil that is building up is coupled to the drive element in such a way that a force acting on the drive element is formed on the basis of the coupling and is transmitted to the wiper blade by way of the linkage in order to bring the wiper blade from the first position into the second position in a linear movement.

In a preferred development, the wiper blade is connected to the linkage by way of a movably mounted frame, so that the movement of the frame, and consequently the change in position of the wiper blade, is performed by way of the linkage.

In a preferred development, the drive element of the electromagnetic drive is connected at one end to a fixed point by way of a spring in such a way that, during the buildup of the force, which acts as a pushing force, the spring is tensioned and forms a resetting force. The resetting force has the effect of bringing the wiper blade from the second position into the first position when the pushing force is reduced or absent.

In a preferred development, the linkage is coupled to a further electromagnetic drive. This electromagnetic drive likewise has a coil through which current flows and which uses a supplied current to build up a magnetic field. The electromagnetic drive has a drive element, which is connected to the linkage in such a way that the drive element moves the linkage linearly. The magnetic field of the coil that is building up is coupled to the drive element in such a way that a force acting on the drive element is formed on the basis of the coupling and is transmitted to the wiper blade by way of the linkage in order to bring the wiper blade from the second position into the first position in a linear movement.

In a preferred development, a liquid cleaning agent is applied to the wiper blade and/or the cover to improve the cleaning effect.

In a preferred development, lighting which is arranged under a cover is provided in the vicinity of the camera. This cover is in this case preferably positioned in such a way that its upper side is likewise cleaned by the movement of the wiper blade.

In a preferred development, a mini camera is used as the camera, the mini camera corresponding in its dimensioning to a camera of a cell phone (also referred to as a “mobile phone” or “mobile”).

In a preferred development, the cleaning assembly with the (mini) camera is arranged on a rail vehicle in a wheel-rail area for optical monitoring tasks. In this area, a wheel of the rail vehicle is in contact with the rail to be traveled over or a track to be traveled over.

In a preferred development, the optically translucent cover is
a cover of an image recorder of a camera,
a cover of an image sensor (cf. CCD chip) of a camera,
a lens element of a camera lens, or
part of a protective housing in which an operational camera is arranged so as to be protected from environmental influences.

In a preferred development, the drive element is a magnet which is arranged inside the coil and is magnetically coupled to it.

The magnet is in this case preferably a bar-shaped permanent magnet, made possible with a minimal volume by an implementation of the invention.

A ferromagnetic, bar-shaped element which, in order to form a magnet, is surrounded by a coil through which current flows is used as a drive element as an alternative to this.

In a further alternative, the drive element is a ferromagnetic material, while the coil is part of a ferromagnetic core. The core is for example designed as a U-shaped yoke. The coil through which current flows together with the core forms a magnetic field which, as a result of the magnetic coupling that is performed, moves the ferromagnetic drive element in the direction of the core.

The present conforms invention to the mechanical specifications required for rail vehicles, given for example in the German industrial standard DIN EN 61373, “Railway applications-rolling stock equipment, shock and vibration tests”. This standard defines predetermined forces and accelerations for devices fitted in the area of the undercarriages that these devices have to withstand.

The present invention is based on an electromagnetic direct drive. The latter uses a magnetic field for forming a force which acts on a drive element and moves it linearly. The drive element in turn acts directly on a load to be moved (here the linkage or frame, wiper blade), which is likewise moved linearly.

The volume of the assembly according to the invention is much smaller than the volume of a cleaning system according to the prior art cited in the introduction.

The assembly according to the invention is reliable in operation and is very robust or not susceptible with respect to faults.

The assembly according to the invention has a simple, and consequently reliable, low-cost construction.

The assembly according to the invention is reduced with respect to the dead weight required, is implemented in a form that is easy to maintain and is of a compact type of design.

The assembly according to the invention is resistant to vibrational shocks.

The invention is explained in more detail below by way of example on the basis of a drawing, in which:

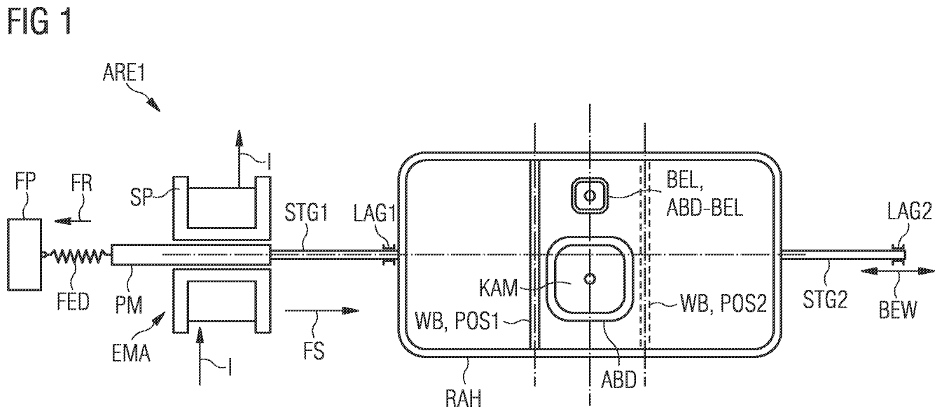

FIG. 1 shows a first embodiment of the assembly according to the invention,

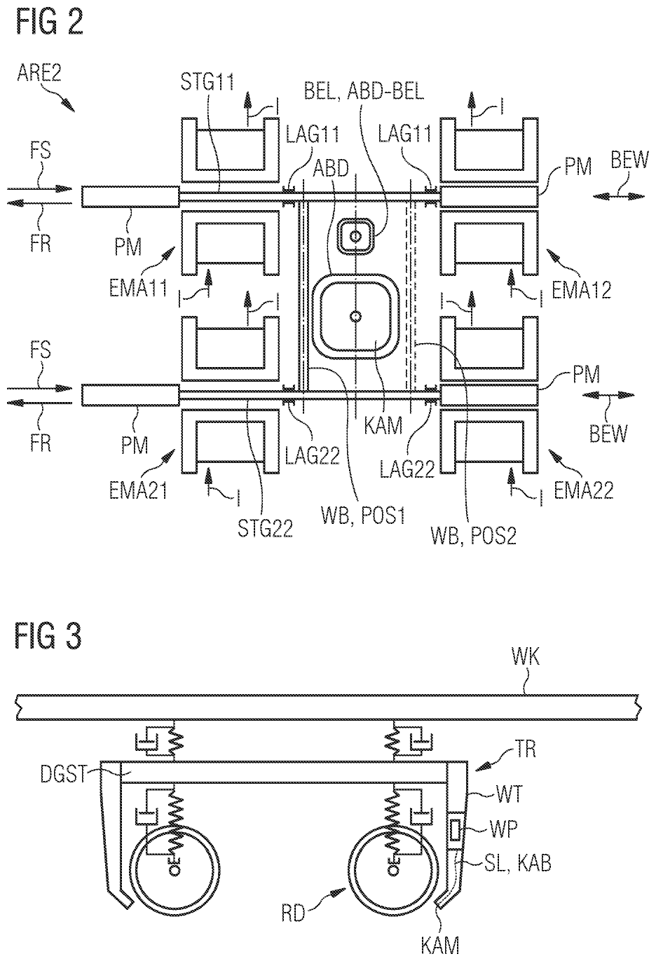

FIG. 2 partially with reference to FIG. 1, shows a second embodiment of the assembly according to the invention, and

FIG. 3 shows an arrangement, given by way of example, of the components of the invention on a rail vehicle.

FIG. 1 shows a first embodiment of the assembly ARE1 according to the invention.

A camera KAM, which is preferably designed as a mini camera, is arranged under a cover ABD so as to be protected from environmental influences.

This cover ABD is cleaned with the aid of a wiper blade WB, which is guided over the cover ABD.

For this purpose, a liquid cleaning agent (for example a water/cleaning agent solution) is applied to the wiper blade WB and/or the cover ABD.

For cleaning, the wiper blade WB is guided linearly over the cover ABD between a first position POS1 and a second position POS2.

The cleaning of the cover ABD, and consequently the camera KAM or the camera optics, is performed by way of the alternating movement BEW of the wiper blade WB between the two positions POS1 and POS2.

For this purpose, the wiper blade WB is fastened on a movably mounted frame RAH. A linear movement of the frame RAH has the effect of implementing the movement of the wiper blade WB between the two positions POS1 and POS2.

For carrying out the linear movement of the frame RAH, it is guided movably.

This is performed here by way of a mounted linkage which is connected to the frame RAH and is described below.

The frame RAH is connected on a first side to a first bar STG1, which is guided by way of a first bearing LAG1.

The frame RAH is connected on a second side to a second bar STG2, which is guided by way of a second bearing LAG2.

With the aid of the two bars STG1, STG2 and the two bearings LAG1, LAG2, the linear movement of the frame RAH is made possible.

The first bar STG1 is coupled to an electromagnetic drive EMA which, as described below, is designed as a direct drive.

The term “direct drive” is understood as meaning an electromagnetic drive in which a linear drive movement is formed by applied magnetic fields. Electromagnetic drives are used in contactors, relays and similar devices.

The electromagnetic drive EMA has by way of example a coil SP, through which an electric current I is passed in order to form a magnetic field of the coil SP.

Arranged inside the coil, and consequently inside the associated magnetic field, is a bar-shaped magnet PM, which is movably mounted in the direction of the longitudinal movement BEW and is designed here as a permanent magnet.

The magnet PM is connected or coupled by its first end to the first bar STG1. It is connected by its second end, which is opposite from the first end, to a fixed point FP by way of a spring FED.

If the electric current I is passed through the coil SP, the magnetic field of the coil SP forms. A magnetic interaction with the magnet PM is used to form a pushing force FS, which acts on the frame RAH, and consequently on the wiper blade WB, by way of the first bar STG1. This has the consequence of triggering the linear movement of the wiper blade WB, which is brought from the first position POS1 to the second position POS2.

The pushing force FS has the effect that the spring FED is tensioned or stretched by way of the movement of the magnet PM, so that a resetting force FR is formed.

If the throughflow of the electric current I in the coil SP is ended, the absent magnetic field of the coil SP has the effect that the interaction with the magnet PM is ended, and correspondingly the pushing force FS no longer occurs.

By way of the tensioned spring FED, the resetting force FR then acts on the bars STG1, STG2, on the frame RAH, and consequently on the wiper blade WB. The wiper blade WB is moved or brought from the second position POS2 into the first position POS1 by the resetting force FR.

This movement has the effect that the spring FED relaxes and the resetting force FR no longer occurs.

A first cleaning cycle has been completed.

With renewed introduction of the electric current I into the coil SP, a second cleaning cycle is started in a way corresponding to the sequence described above.

In order to improve the recording situation of the camera KAM, lighting BEL is provided in the vicinity of the camera KAM. The lighting BEL is likewise arranged under a cover ABD-BEL. This cover ABD-BEL is positioned in such a way that its upper side is likewise cleaned by the movement of the wiper blade WB.

The two covers ABD-BEL and ABD are preferably combined to form a common or continuous cover.

FIG. 2 shows, partially with reference to elements of FIG. 1, a second embodiment of the assembly ARE2 according to the invention.

The camera KAM, which is preferably designed as a mini camera, is again arranged under the cover ABD so as to be protected from environmental influences.

This cover ABD is cleaned with the aid of the wiper blade WB, which is guided over the cover ABD, in a guided linear movement.

A liquid cleaning agent (for example a water/cleaning agent solution) is applied to the wiper blade WB and/or the cover ABD.

For cleaning, the wiper blade WB is guided linearly over the cover ABD between a first position POS1 and a second position POS2.

The cleaning of the cover ABD, and consequently the camera KAM or the associated camera optics, is performed by way of the alternating linear movement BEW of the wiper blade WB between the two positions POS1 and POS2.

For this purpose, the wiper blade WB is connected at a first end to a first bar STG11, which is guided by way of bearings LAG11.

The wiper blade WB is additionally connected at a second end, which is opposite from the first end, to a second bar STG22, which is guided by way of bearings LAG22.

The linear movement of the wiper blade WB is made possible or implemented by way of the two bars STG11, STG22 and by way of the bearings LAG11, LAG22.

The first bar STG11 is coupled by a first end to a first electromagnetic drive EMA11, which in turn is designed as a direct drive.

The second bar STG22 is coupled by a first end to a second electromagnetic drive EMA21, which is likewise designed as a direct drive.

For the functionality of the two electromagnetic drives EMA11, EMA21, reference is made to the statements made with respect to FIG. 1.

If the electric current I is passed through the coil of the first drive EMA11, a magnetic field of the coil forms. The associated magnetic interaction with the magnet PM is used to form a pushing force FS, which acts on the wiper blade WB by way of the first bar STG11. As a result, a linear movement of the wiper blade WB from the first position POS1 to the second position POS2 is triggered or carried out.

The same applies to the coil of the second drive EMA21. If the electric current I is passed through it, a magnetic field of the coil forms. The associated magnetic interaction with the magnet PM is used to form a pushing force FS, which acts on the wiper blade WB by way of the second bar STG22. As a result, the linear movement of the wiper blade WB from the first position POS1 to the second position POS2 is triggered or carried out.

If the throughflow of the electric current I in the coils of the two drives EMA11, EMA21 is subsequently ended, the interaction with the permanent magnets PM no longer occurs due to the absent magnetic field of the coil, and the pushing force FS ends. The two electromagnetic drives EMA11, EMA21 then cease to function.

The resetting or return of the wiper blade WB from the second position POS2 to the first position POS1 is performed by the two electromagnetic drives EMA12, EMA22.

For the resetting, the first bar STG11 is coupled by a second end to a third electromagnetic drive EMA12, which is again designed as a direct drive.

The second bar STG22 is coupled by a second end to a fourth electromagnetic drive EMA22, which is likewise designed as a direct drive.

For the functionality of the two electromagnetic drives EMA12, EMA22, reference is made to the statements made with respect to FIG. 1.

If the electric current I is passed through the coil of the third drive EMA12, a magnetic field of the coil forms. The associated magnetic interaction with the magnet PM is used to form a resetting force FR, which acts on the wiper blade WB by way of the first bar STG11. As a result, a linear movement of the wiper blade WB from the second position POS2 to the first position POS1 is triggered or carried out.

The same applies to the coil of the fourth drive EMA22. If the electric current I is passed through it, a magnetic field of the coil forms. The associated magnetic interaction with the magnet PM is used to form a resetting force FR, which acts on the wiper blade WB by way of the second bar STG22.

As a result, the linear movement of the wiper blade WB from the second position POS2 to the first position POS1 is triggered or carried out.

If the throughflow of the electric current I in the coils of the two drives EMA12, EMA22 is subsequently ended, the interaction with the permanent magnets PM no longer occurs due to the absent magnetic field of the coil, and the resetting force FR ends. The two electromagnetic drives EMA12, EMA22 then cease to function.

A first cleaning cycle has consequently been completed.

With renewed introduction of the electric current I into the coils of the two electromagnetic drives EMA11, EMA21, a second cleaning cycle is started in a way corresponding to the sequence described above.

With reference to the two figures, FIG. 1 and FIG. 2, the following mixed forms that are not shown in any more detail are conceivable:

With reference to FIG. 1, the wiper blade is connected directly to the bars STG1, STG2 of the linkage; the frame RAH is omitted.

With reference to FIG. 1, the buildup of the resetting force FR is performed with the aid of a drive which is comparable to the drive EMA12 and is connected to the second bar STG2. The spring FED is correspondingly omitted.

With reference to FIG. 2, the wiper blade is connected by way of a frame to one of the bars, that is to say either STG11 or STG22. The other bar and the drives EMA21 and EMA22 could then be omitted, in a way corresponding to the functionality described in FIG. 1.

With reference to FIG. 2, the buildup of the resetting force FR is performed with the aid of a spring, in a way corresponding to the functionality described in FIG. 1.

FIG. 3 shows an arrangement, given by way of example, of components of the invention on a rail vehicle.

Of the rail vehicle, a railcar body WK with a bogie DGST, on which a wheel is fastened, is shown.

The assembly described in the figures FIG. 1 or FIG. 2 is arranged in the wheel-rail area of the rail vehicle.

For this purpose, the assembly described in the figures FIG. 1 or FIG. 2 is fastened on a beam TR of the bogie.

Integrated in the beam or fastened on it are a washer-fluid tank WT, a washer-fluid pump WP, a washer-fluid hose SL and electric cables KAB in order to functionally activate or operate the camera KAM and the associated cleaning.

The camera and the cleaning are for example activated or operated with the aid of software.

The software detects as soon as the cover of the camera is soiled and initiates the cleaning described above.

It is advantageous to perform the cleaning during a stop of the rail vehicle at a station or during the operational standstill of the rail vehicle on open track.

The software is preferably designed in such a way that it detects a failure of cleaning components and triggers an (alarm) signal intended for the driver, for example
if no wiper blade movement is performed because the wiper blade is jammed or blocked in the movement sequence,
if the liquid cleaning agent used is sprayed on or supplied to the cleaning system unevenly,
if there is an insufficient pressure at a cleaning agent nozzle,
if there is a malfunction of a wiper switch or a selector switch for a required operating mode,
etc.

1-8. (canceled)

9. An assembly for cleaning an optically translucent cover of a camera, wherein the camera is disposed under the optically translucent cover so as to be protected from environmental influences, the assembly comprising:
a wiper blade for guiding over the optically translucent cover for cleaning the optically translucent cover;
a mounted linkage connected to said wiper blade, via said mounted linkage said wiper blade being moved over the optically translucent cover between a first position and a second position; and
an electromagnetic drive coupled to said mounted linkage, said electromagnetic drive having a coil through which current flows and said coil using a supplied current to build up a magnetic field, said electromagnetic drive further having a drive element, being connected to said mounted linkage such that said drive element moves said mounted linkage linearly, the magnetic field of said coil that is building up is coupled to said drive element such that a force acting on said drive element is formed on a basis of a coupling and is transmitted to said wiper blade by way of said mounted linkage to bring said wiper blade from the first position into the second position in a linear movement.

10. The assembly according to claim 9, further comprising a movably mounted frame, said wiper blade is connected to said mounted linkage by way of said movably mounted frame, so that a movement of said movably mounted frame, and consequently a change in position of said wiper blade, is performed by way of said mounted linkage.

11. The assembly according to claim 9, further comprising:
a fixed point; and
a spring, said drive element of said electromagnetic drive is connected at one end to said fixed point by way of said spring such that, during a buildup of the force, which acts as a pushing force, said spring is tensioned and forms a resetting force, the resetting force having an effect of bringing said wiper blade from the second position into the first position when the pushing force is reduced or absent.

12. The assembly according to claim 9,
further comprising a further electromagnetic drive coupled to said mounted linkage;
wherein said electromagnetic drive has said coil through which the current flows and which uses the supplied current to build up the magnetic field, said electromagnetic drive has said drive element, which is connected to said mounted linkage such that said drive element moves said mounted linkage linearly; and
wherein the magnetic field of said coil that is building up is coupled to said drive element such that the force acting on said drive element is formed on a basis of the coupling and is transmitted to said wiper blade by way of said mounted linkage in order to bring said wiper blade from the second position into the first position in the linear movement.

13. The assembly according to claim 9, further comprising a liquid cleaning agent being applied to said wiper blade and/or the optically translucent cover to improve a cleaning effect.

14. The assembly according to claim 9, further comprising:
a lighting cover; and
lighting disposed under said lighting cover and disposed in a vicinity of the camera, said lighting cover is positioned such that an upper side of said lighting cover is likewise cleaned by a movement of said wiper blade.

15. The assembly according to claim 9, wherein said drive element is a magnet which is disposed inside said coil.

16. The assembly according to claim 9, wherein:
said drive element is formed from a ferromagnetic material; and
said coil is part of a ferromagnetic core which implements a magnetic coupling of said drive element to the magnetic field of said coil.

17. The assembly according to claim 15, wherein said magnet is a permanent magnet.

18. The assembly according to claim 16, wherein said ferromagnetic material is iron.
